(19) United States
(12) Patent Application Publication
(10) Pub. No.: US 2003/0068823 A1
(43) Pub. Date: Apr. 10, 2003

(54) Remote process control system

(75) Inventors: Eric R. Alling, Upton, MA (US); Clare R. Sokolowski, Boston, MA (US)

Correspondence Address: EDWARDS & ANGELL, LLP, Dike, Bronstein, Roberts & Cushman, IP Group, 130 Water Street, Boston, MA, 02109, US

(73) Assignee: Shipley Company, L.L.C., Marlborough, MA (US)

(21) Appl. No.: 09/809,661

(22) Filed: Mar. 15, 2001

(51) Int. Cl. G05D 7/00

(52) U.S. Cl. 436/55; 422/62; 422/105; 422/110

(57) ABSTRACT

A system that includes an analyzer module that is in communications with the equipment and that monitors the operation of the equipment and generates an operations analysis. A control host is included that receives the operations analysis and determines therefrom whether the equipment is operating efficiently. The control host is in communications with the equipment for adjusting the at least one parameter setting so that when the control host determines that the equipment is not operating efficiently, the control host adjusts the at least one parameter setting until the equipment is operating efficiently.

### BACKGROUND

The following invention relates to a system for monitoring equipment and, in particular, for controlling the operational parameters of equipment for maintaining manufacturing efficiency.

Manufacturing efficiency is often a manufacturer's primary competitive edge in the marketplace. This is especially the case for manufacturers of commodity products where a slight decline in manufacturing yield may be the difference between profit and loss. Thus, it is important for manufacturers to maintain their manufacturing equipment at optimal performance levels.

Maintaining manufacturing efficiency typically requires an operator to continuously monitor the manufacturing equipment and output and adjust the equipment to keep manufacturing yield in an optimum range. For example, when using plating equipment to copper plate electronic components by immersing the electronic components in a plating bath, a number of parameters must be set including the replenishment flow rate, the agitation rate and the current density. During the plating process, however, these parameter settings tend to drift as a result of contaminants that deplete the bath activity, anode aging and changes in the agitation rate. Typically, the operator becomes aware of parameter drift by examining the plating rate and determining whether the plating rate is within the specifications for optimal performance. Once parameter drift is spotted, the operator then repeatedly adjusts the operating parameters until the plating rate is once again in the optimum range. As a result, the operator must monitor the plating rate and adjust the operating parameters according to maintain optimal plating activity and performance.

Reliance on an operator for analyzing the plating rate and repeatedly readjusting the operating parameters to achieve optimum performance is inefficient and costly. First, because parameter drift constantly occurs, especially in high-volume plating operations, the plating rate must be checked continuously so that optimal performance is maximized. A human operator, however, cannot practically monitor the plating rate continuously in real-time. Furthermore, once the operator determines that the plating rate is out of spec, the operator may have to adjust the parameter settings numerous times until the plating rate is as desired. In the interim, the plating process operates below peak efficiency. Thus, because the operator typically will not identify parameter drift as soon as it occurs and there is a delay from the time the operator identifies drift until the time the operator successfully readjusts the operating parameters, the plating equipment will operate at less than optimal performance for a significant period of time.

Prior art tools exist for monitoring the electroplating equipment to determine whether the plating process is operating optimally. One such tool, provided by Technic, Inc. (http://www.teclmic.com/), automatically and continuously samples the plating bath chemistry and, using liquid analysis techniques such as mass spectrometry, determines the plating rate of the process. Based on this plating rate, the operator may adjust the equipment parameters to improve plating activity.

Although plating bath analyzers, such as the Technic tool, provides automatic, real-time analysis of the plating bath chemistry, the operator must still view the analyzer results, make a determination as to which parameters must be adjusted to compensate for drift and repeatedly adjust the parameters until the plating activity returns to an optimal range. As discussed above, reliance on an operator to ensure that the plating equipment is operating at peak performance introduces inefficiencies and costs into the process.

Accordingly, it is desirable to provide a system for automatically monitoring the operation of equipment and adjusting the operational parameters of such equipment in order to maintain manufacturing efficiency.

### SUMMARY OF THE INVENTION

The present invention is directed to overcoming the drawbacks of the prior art. Under the present invention a system is provided for controlling the operation of equipment where the operation of the equipment is adjustable via at least one parameter setting. The system of the present invention includes an analyzer module that is in communications with the equipment and that monitors the operation of the equipment and generates an operations analysis. A control host is included that receives the operations analysis and determines therefrom whether the equipment is operating efficiently. The control host is in communications with the equipment for adjusting the at least one parameter setting so that when the control host determines that the equipment is not operating efficiently, the control host adjusts the at least one parameter setting until the equipment is operating efficiently.

In an exemplary embodiment, the analyzer module monitors the operation of the equipment continuously and communicates with the control host via a remote communications link such as, by way of non-limiting example, the Internet.

In another exemplary embodiment, the control host determines whether the equipment is operating efficiently based on predetermined operational specifications for the equipment and the control host adjusts the at least one parameter setting based on a predetermined set of operational parameters for the equipment.

In yet another exemplary embodiment, the control host maintains a log of previous settings of the at least one parameter setting and the control host adjusts the at least one parameter setting based on the log of previous settings.

In still yet another exemplary embodiment, the control host adjusts the equipment via a remote communications link such as, by way of non-limiting example, the Internet.

Accordingly, a system is provided for automatically monitoring the operation of equipment and adjusting the operational parameters of such equipment in order to maintain manufacturing efficiency.

The invention accordingly comprises the features of construction, combination of elements and arrangement of parts that will be exemplified in the following detailed disclosure, and the scope of the invention will be indicated in the claims. Other features and advantages of the invention will be apparent from the description, the drawings and the claims.

### DESCRIPTION OF THE DRAWINGS

For a fuller understanding of the invention, reference is made to the following description taken in conjunction with the accompanying drawings, in which:

FIG. 1 is a block diagram of a system for controlling the operation of equipment in accordance with the present invention; and

FIG. 2 is a flowchart of a control loop mechanism provided by the system of FIG. 1.

### DETAILED DESCRIPTION OF THE PREFERRED EMBODIMENTS

Referring now to FIG. 1, there is shown a block diagram of a system 1 for controlling the operation of processing equipment 3 in accordance with the present invention. System 1 may be used to control any type of processing equipment 3 that requires the adjustment of parameter settings to operate optimally and that such parameter settings drift over time thereby causing the equipment to operate less than optimally. Such parameters may include, by way of non-limiting example, equipment settings and the amount of composition of raw materials such as, for instance, the amount and composition of chemistry used in operating the processing equipment. System 1 includes an analyzer module 5 that is capable of monitoring the operations of processing equipment 3 and providing an analysis of the operations of processing equipment 3. The analysis provided by analyzer module 5 may include the analysis of any aspect of operation of processing equipment 3 that may be used to determine the operating efficiency of processing equipment 3 including, but not limited to, an analysis of the operating environment of processing equipment 3 and the output generated by equipment 3. In an exemplary embodiment, analyzer module 5 automatically and continuously monitors equipment 3 and provides an analysis of the operation of processing equipment 3 in real-time. Analyzer module 5 outputs the operations analysis of processing equipment 3 in a suitable format including, but not limited to, an electronic or computer-readable format.

For example, with respect to controlling the operation of a plating bath and associated equipment, a plating bath analyzer, such as the Technic tool described above, automatically and continuously analyzes the plating bath chemistry and provides an analysis of the chemistry contents that is indicative of the operating efficiency of the plating equipment. In this case, the analysis may include, by way of non-limiting example, the concentration of sulfites in the plating bath including the amounts of suppressor and accelerator chemistry. The plating bath analyzer then outputs the analysis of the operation of the plating bath and equipment in a computer-readable format.

System 1 includes a controller interface 7 that receives the operations analysis provided by analyzer module 5 and transmits the operations analysis to a control host 9 via a communications link 11. It will be obvious to one of ordinary skill to design controller interface 7 and control host 9 to communicate with each other via any communications medium such as, by way of non-limiting example, the Internet. For example, controller interface 7 may include a web server that receives the analysis output from analyzer module 5 in a computer-readable format and transmits the analysis via the Internet to control host 9 that also includes a web server.

Control host 9 receives the operations analysis provided by analyzer module 5 and determines therefrom whether the operation of processing equipment 3 is within an optimal range. To make such determination, control host 9 has stored therein the operational specification of processing equipment 3 and what the optimal performance of equipment 3 should be based on a given set of parameters. The operational specification of processing equipment 3 may depend on, by way of non-limiting example, a target operation range established by the equipment manufacturer, raw material supplier/manufacturer (for e.g. the chemistry supplier) and the entity operating processing equipment 3. Control host 9 then compares the theoretical optimal performance of processing equipment 3 to the actual performance as measured by analyzer module 5 to determine whether processing equipment 3 is operating optimally. Control host 9 makes this comparison using a variety of techniques such as, for example, by table lookup or mathematical computation. For example, for controlling a plating bath and equipment, control host 9 has stored therein the expected optimal operating conditions of the plating bath and equipment based on various combinations of operation parameters, such as flow rate, agitation rate, temperature, rotation rate and current density, as well as on having an optimized concentration of chemistry in the plating bath. Based on the expected optimal operating conditions, control host 9 determines whether the actual conditions of the plating bath and equipment are in the optimal range.

If control host 9 determines that processing equipment 3 is not operating in an optimal range, then control host 9 determines the necessary adjustments to be made to the parameter settings of processing equipment 3 so that the operation of processing equipment 3 returns to the optimal range. Control host 9 determines the necessary adjustment to be made based on various factors including, but not limited to, the existing parameter settings of processing equipment 3 and predetermined operational parameter settings for which processing equipment 3 would operate in an optimal range. Control host 9 makes this determination by using a variety of techniques such as, for example, by applying known mathematical computations to the various factors and/or by comparing the present parameter settings and operation of processing equipment 3 to the various factors.

In an exemplary embodiment, control host 9 logs previous parameter settings of equipment 3 as well as the adjustments to such parameter settings that were necessary to restore the operation of processing equipment 3 to an optimal range. Based on the log of previous parameter settings, control host 9 determines whether any deviation exists in the current operational specifications of equipment 3 as compared to the original specifications for processing equipment 3. Control host 9 then factors any such deviation into any adjustments to be made to the parameter settings of processing equipment 3 to restore operations to an optimal range.

Once the necessary adjustments to the parameter settings are determined, control host 9 communicates the adjustment information to controller interface 7 via communications link 11. Controller interface 7 transmits the adjustment information to processing equipment 3 via a controller link 13. The parameter settings of processing equipment 3 are then adjusted according to the received adjustment information. In an exemplary embodiment, controller link is a RS-232 serial connection that mates to an RS-232 communications port on processing equipment 3. The RS-232 communications port receives the adjustment information and the parameter settings of processing equipment 3 are adjusted based thereon. It will be obvious to one of ordinary skill to provide any other type of interface between controller interface 7 and processing equipment 3 for communicating adjustment information to processing equipment 3 including, but not limited to, universal serial bus, parallel or a proprietary interface. Thus, by adjusting the parameter settings of processing equipment 3, a control loop is provided for maintaining the operation of processing equipment 3 in an optimal range.

In an exemplary embodiment, an access device 15, for example a personal computer, is in communications with control host 9 and is operated by technical personnel for monitoring the operations analysis of processing equipment 3 and the provided parameter settings adjustments. Based on the review of this information, the technical personnel can assess whether control loop mechanism provided by system 1 is stable or drifting. The control loop mechanism may drift for several reasons such as because of anode depletion or multiple byproduct species being convolved creating a hysteysis effect after replenishment. If the control loop is drifting, the technical personnel may manually override control host 9 and provide corrective parameter settings for restoring the operation of processing equipment 3 to the optimal range. These corrective parameter settings are communicated by control host 9 to controller interface 7 which are then used to adjust the parameter settings of processing equipment 3, in the manner described above.

Referring now to FIG. 2, there is shown a flowchart of the control loop mechanism provided by system 1 of the present invention. Initially, in Step 1, a connection is established between controller interface 7 and control host 9 in order to establish the control loop mechanism of system 1. Next, in Step 2, analyzer module 5 analyzes the operation of processing equipment 3 and provides an operations analysis to controller interface 7. In Step 3, control host 9 receives the operations analysis from controller interface 7 and, in Step 4, determines whether equipment 3 is operating in an optimal range. If control host 9 determines that processing equipment 3 is operating optimally then, in Step 5, the operations analysis is logged by control host 9. Periodically, in Step 6, the data logged by control host 9 is checked by technical personnel. The method then returns to Step 2 in which analyzer module 5 provides another operations analysis to controller interface 7.

If, however, in Step 4 control host 9 determines that processing equipment 3 is not operating in an optimal range, then the method proceeds to Step 7, in which control host 9 determines the adjustments that need to be made to the parameter settings of processing equipment 3 in order for equipment 3 to operate optimally. Next, in Step 8, the operations analysis and the corresponding adjustments are logged by control host 9 for future analysis, as described above. In Step 9, the adjustments are communicated to controller interface 7 and are made to the parameter settings of processing equipment 3. Once the adjustments are made, the method returns to Step 2 in which analyzer module 5 provides another operations analysis to controller interface 7. Thus, the method of FIG. 2 performs a continuous loop in which the efficiency of the operations of processing equipment 3 is analyzed and any necessary adjustments to parameter settings are made so that processing equipment 3 operates in an optimal range.

Based on the above description, it will be obvious to one of ordinary skill to have control host 9 control the operations of numerous pieces of equipment. In this scenario, control host 9 communicates with a plurality of controller interfaces and receives from each controller interface an operations analysis for each corresponding piece of equipment. For each piece of equipment, control host determines whether the piece of equipment is operating optimally and, if not, sends to the equipment parameter setting adjustments so that the equipment operation returns to an optimal range.

Accordingly, a system is provided for automatically monitoring the operation of equipment and, if it is determined that the equipment operation is not within an optimal range, adjusting the parameters settings of the equipment so that the equipment operation returns to the optimal range.

It will thus be seen that the objects set forth above, among those made apparent from the preceding description, are efficiently attained and, since certain changes may be made in carrying out the above process, in a described product, and in the construction set forth without departing from the spirit and scope of the invention, it is intended that all matter contained in the above description shown in the accompanying drawing shall be interpreted as illustrative and not in a limiting sense.

It is also to be understood that the following claims are intended to cover all of the generic and specific features of the invention herein described, and all statements of the scope of the invention, which, as a matter of language, might be said to fall therebetween.

1. A system for controlling the operation of equipment, said operation of said equipment being adjustable via at least one parameter setting, comprising:
an analyzer module in communications with said equipment, said analyzer module monitoring said operation of said equipment and generating an operations analysis;
a control host, said control host receiving said operations analysis and determining therefrom whether said equipment is operating efficiently, said control host being in communications with said equipment for adjusting said at least one parameter setting;
wherein when said control host determines that said equipment is not operating efficiently, said control host adjusts said at least one parameter setting until said equipment is operating efficiently.

2. The system of claim 1, wherein said analyzer module monitors said operation of said equipment continuously.

3. The system of claim 1, wherein said control host is in remote communications with said analyzer module.

4. The system of claim 3, wherein said remote communications is via the Internet.

5. The system of claim 1, wherein said control host determines whether said equipment is operating efficiently based on predetermined operation specifications for said equipment.

6. The system of claim 1, wherein said control host adjusts said at least one parameter setting based on a predetermined set of operational parameters for said equipment.

7. The system of claim 6, wherein said control host maintains a log of previous settings of said at least one parameter setting and said control host adjusts said at least one parameter setting based on said log of previous settings.

8. The system of claim 1, wherein said control host is in remote communications with said equipment for adjusting said at least one parameter setting.

9. The system of claim 8, wherein said remote communications is via the Internet.

10. The system of claim 1, wherein said equipment is electroplating equipment generating a plating rate, said operation analysis includes an analysis of said plating rate and wherein said at least one parameter setting is selected from the group of replenishment flow rate(s) and agitation rate.

11. A method for controlling the operation of equipment, said operation of said equipment being adjustable via at least one parameter setting, comprising the steps of:
monitoring said operation of said equipment;
generating an operations analysis of said equipment;
determining whether said equipment is operating efficiently based on said operations analysis; and
adjusting said at least one parameter setting until said equipment is operating efficiently.

12. The method of claim 11, wherein the step of monitoring said operation of said equipment includes the step of:
monitoring said operation of said equipment continuously.

13. The method of claim 1 1, further comprising the step of:
remotely receiving said operations analysis.

14. The method of claim 11, wherein the step of determining whether said equipment is operating efficiently includes the step of:
determining whether said equipment is operating efficiently based on predetermined operation specifications for said equipment.

15. The method of claim 11, wherein the step of adjusting said at least one parameter setting includes the step of:
adjusting said at least one parameter setting based on a predetermined set of operational parameters for said equipment.

16. The method of claim 15, further comprising the step of:
maintaining a log of previous settings of said at least one parameter setting; and wherein the step of adjusting said at least one parameter setting includes the step of:
adjusting said at least one parameter setting based on said log of previous settings.

17. The method of claim 11, wherein the step of adjusting said at least one parameter setting includes the step of:
remotely adjusting said at least one parameter setting.

18. The method of claim 1, wherein said equipment is electroplating equipment generating a plating rate, said operation analysis includes an analysis of said plating rate and wherein said at least one parameter setting is selected from the group of replenishment flow rate and agitation rate.
